(19) United States
(12) Patent Application Publication
(10) Pub. No.: US 2011/0236841 A1
(43) Pub. Date: Sep. 29, 2011

(54) Candle holder insert

(76) Inventor: Mary Elise Buhl Chapman, New Vernon, NJ (US)

(21) Appl. No.: 12/661,747

(22) Filed: Mar. 23, 2010

(51) Int. Cl. F21V 35/00

(52) U.S. Cl. 431/297

(57) ABSTRACT

A candle insert stabilizes a candle within a candle holder. The candle insert comprises a sleeve having a top opening and side walls. The side walls of the sleeve have an external surface appointed to engage with a socket of a candle holder. An internal cavity of the sleeve is appointed to receive and engage with a candle base. The top opening of the sleeve has a substantially annular shape and is appointed to receive the base of the candle. A plurality of grooves and ridges are integrated within the external surface and the internal cavity of the side walls. The grooves and ridges cooperate in concert to reduce sliding friction during mounting and removal of the candle insert within the candle holder, and stabilize the candle during residence therein.

### BACKGROUND OF THE INVENTION

1. Field Of The Invention

The present invention relates to a candle holder insert; and more particularly to a candle insert comprising a sleeve with a top opening and side walls having a plurality of grooves and ridges integrated therein, that cooperate in concert to reduce coefficient of sliding friction during mounting and removal of the candle insert within a candle holder, and stabilize the candle during residence therein.

2. Description of the Prior Art

Candles are typically made of paraffin, stearin, beeswax, gel, some plant waxes, or tallow. The candle is produced in various colors, shapes, sizes and scents. The size of the flame and corresponding rate of burning is controlled largely by the candle wick. Annular shaped candles are often the most common shape utilized, though a plethora of candle shapes can be provided including triangular, star shaped, oval, square, hexagonal, and the like. According to the National Fire Protection Association, candles are one of the leading sources of residential fires with almost 10% of civilian injuries and 6% of civilian fatalities attributed to candles. John Hall, NFPA 2009, http://www.nfpa.org/assets/files//PDF/Research/Fire_overview_2009.pdf.

Despite fire dangers, candles are prevalently used both for necessity and for pleasure as more and more people enjoy the relaxing effect of a candlelit environment. Although candle holders are utilized to provide both decoration and upright presentment of a burning candle for safety, candle holders fail to provide the requisite stabilization to ensure the candle does not topple over. Often the base of the candle, especially where federal and the taper candles are involved, will either be smooth or include continuous horizontally helical grooves or vertical parallel grooves for being received within a socket of a candle holder. While many candle holders use a friction-tight socket in order to keep the candle upright, if a candle is slightly too narrow it will wobble. Wobbly candles pose a significant risk of causing a fire as the candle is prone to falling over while burning. Traditionally, the candle and candle holders were made in the same place so they were appropriately sized; but international trade has combined the modern candle with existing holders, which makes the ill-fitting candle more common.

In order to address this risk, prior art workers have attempted to construct inserts for candle holders. Despite these attempts, fires from overturning candles due to ill-fitment in candle holders has not been lessoned. That is because the heretofore disclosed and utilized inserts do not provide optimal stability to the candle in a discrete manner.

Various candle holder inserts have been provided using a construction involving a sleeve having upstanding spaced arms or tongues appointed to grasp the candle. Generally in operation, these types of insert devices expand during insertion of the candle base and contract when the candle is received into the sleeve. Due to the different configurations of candlestick bottoms or candle bases—including smooth surface bottoms, continuous horizontally helical grooves or vertical parallel grooves—these devices' arms/tongues/grooves or fingers are not received well on the candle base and do not provide an optimal fit for stabilization. That is to say, the vertically spaced flexing arms/tongues/grooves cannot adequately house a candle base having continuous horizontally helical grooves. Even candles having vertical parallel grooves are often ill-fit with these types of inserts as the vertically spaced flexing arms/tongues/grooves cannot adequately align with the grooves of the candle's base. Moreover, insertion can become cumbersome where at least one of the vertically spaced flexing arms/tongues/grooves do not adequately align with the candle base.

Examples of such devices generally having vertically spaced flexing arms/tongues/grooves can be found in the following publications. U.S. Patent No. 273,103 to Keibel discloses a candle-holder or attachment to a candlestick or chandelier that comprises a preferably conical or tapering sleeve or thimble that is screw-threaded upon its interior periphery. The sleeve or thimble is preferably cut away to form tongues or fingers. U.S. Patent No. 388,894 to Masson-Chevallier discloses a candle-holder consisting, essentially, of a saucer-like sconce of metallic spring-clips for securely holding the candle, as well as for retaining and extinguishing the remnant of the burning wick when the candle has burned down to the end. U.S. Patent No. 422,989 to Stelzner discloses a candle-holder having six elastic tongues—three to adjust themselves within the socket of the candlestick and three to grasp and support the candle, wherein the tongues may conveniently be bent or shaped to better adapt themselves to the surfaces against which they are made to work. U.S. Patent No. 441,625 to Wohlmuth discloses a simple and inexpensive candle holder formed of a truncated cone, or substantially so, and is provided with a series of flexible or elastic tongues. U.S. Pat. No. 2,775,882 to Doig discloses a candle holder comprising a container and a cap, the cap being formed at the bottom thereof with a pair of cutting edges which project upwardly from the bottom of the holder. U.S. Pat. No. 2,981,087 to Peiser discloses a candle holder formed from a flat metal stamping comprising a body having a plurality of upstanding lugs or ears. The body is connected by a neck to spaced feet separated from each other by a slot which preferably extends upwardly into the neck. The lower edge of the feet are slotted so that the feet adjust themselves to a socket. U.S. Pat. No. 3,918,888 to Clarke et al. discloses an adapter for a candle holder comprising a base wall and a plurality of upstanding arms spaced around the periphery of the base wall. The arms are somewhat accurately shaped in vertical cross-section for engaging a candle between the arms. U.S. Pat. No. 4,544,351 to Marsicano discloses a candle holder formed of paper, plastic or the like which can be inserted into a hollow article such as a glass for the purpose of providing a support for a candle in the case of an emergency or when a conventional candle holder is not available. The candle holder comprises radially inwardly extending slits at the center portion thereof which define generally triangular inner tabs for frictionally engaging a candle. U.S. Pat. No. 6,709,266 to Jensen discloses a candle holder comprising an annular collar and a bottom disc interconnected by ribs having sharp edges for trimming a candle end inserted in the cavity defined by the ribs. Resilient arms are provided for stably securing the candle in the socket of a candlestick. U.S. Design Patent No. D264,004 to Swan discloses an ornamental design for an adapter for candlesticks having exterior vertical grooves. Foreign Publication No. WO/2009/085008 to Hägglund et al. discloses a candle holder having a sleeve comprising at least two slots extending upwards and at least two slots extending downward.

Other candle holders include insert type devices either integrated within holders or appointed to be used with a specific type of holder, i.e. having helical screw-thread grooves, and the like. The inserts cannot be used for a holder not specifically designed for congenital use. For example, see U.S. Pat. No. 2,527,707 to Curtis discloses a decorative candle holder appointed for attachment to different bases. The holder comprises a lower base portion provided with a central cylindrical threaded aperture, an intermediate base portion provided with a plane circular upper face having a central threaded recess, and a body portion. German Publication No. DE3923033 to Eckhard discloses a commercial candle stand comprising three parts: a candle holder, a tube piece and a foot portion. U.S. Patent Publication No. 2008/0070175 to Marklin discloses a candle insert including an elongated tubular member having an internal bore. An enlarged disc-shaped end piece located at the proximate end contains an indented portion capable of receiving a torque producing tool. The elongated tubular member contains external threading extending along an outside surface of the elongated tubular member.

Other candle inserts provide ribs or horizontal cross-sections for fitting the candle and insert into a holder socket. These devices fail to provide optimal stability as some of the devices are provided as being constructed of an elastic material, which causes deformation and therefore causes them to become susceptible to wobbling. For example, U.S. Pat. No. 1,609,130 to Schacht discloses an adapter lining made of elastic material. A plurality of ribs disposed on the adaptor lining's interior and exterior operate to stretch, and thereby fit around the lower end of a candle. The ribs slightly flatten or bend over against the wall of socket of the holder. Other such types of devices are adapted to be utilized with a bottle top, and include decorative flanges so that the insert is not discrete in nature. For example, U.S. Patent No. 3,726,632 to Connolly discloses a candle holder that includes a flange which rests upon an open top wall of a bottle's neck. A depending skirt is zig-zagged shaped in horizontal cross-section in such a manner as to create a plurality of co-accurate inner edges and a plurality of co-actuate outer edges. The inner edges fit snugly against the inner wall of the neck while the outer edges grip a candle.

Despite attempts to construct a candle holder insert capable of providing stability to candles in a holder, instability of candles still poses a problem to consumers. Consequently, there remains a need in the art for a candle insert that tightly receives a candle base and fits within a socket of a holder in a discrete manner. There is a further need in the art for a candle insert that fits within the upper tubular portion/socket of a candle holder unit and has grooves and ridges that enable the candle insert to be securely mounted within the socket of the candle holder unit without damaging or scratching the unit.

### SUMMARY OF THE INVENTION

The present invention provides a candle holder insert capable of providing stability to candles in a holder. Preferably the insert is non deformable to provide enhanced stability to the candle retained therein and mitigate wobbling or side to side movement. The candle insert tightly receives a candle base and fits within a socket of a holder in a discrete manner. Fitting of the candle insert within the upper tubular portion/socket of a candle holder unit is facilitated by grooves and ridges that enable the candle insert to be securely mounted within the socket of the candle holder unit without damaging or scratching the unit.

The candle insert is constructed with a sleeve having a top opening and side walls. The side walls of the sleeve have an external surface appointed to engage with a socket of a candle holder, and an internal cavity appointed to receive and engage with a base of a candle. The top opening of the sleeve has a substantially annular shape and is appointed to receive the base of the candle. A plurality of grooves and ridges are integrated within the external surface and the internal cavity of the side walls. The grooves and ridges cooperate in concert to reduce the coefficient of sliding friction during mounting and removal of the candle insert within the candle holder, and to stabilize the candle during residence therein.

### BRIEF DESCRIPTION OF THE DRAWINGS

The invention will be more fully understood and further advantages will become apparent when reference is had to the following detailed description of the preferred embodiments of the invention and the accompanying drawings, in which:

FIG. 1a illustrates a candle within an embodiment of the candle insert thereon mounted in a candlestick holder unit;

FIG. 1b shows a top plane view of the candle insert embodiment of FIG. 1a;

FIG. 2 shows a top plane view of an embodiment of the candle insert wherein the insert is constructed with shallow side walls;

FIGS. 3a-3d show top plane views of embodiments of the candle insert, showing six point, seven point, eight point and ten point star configurations of the candle insert; and

FIG. 4 shows a top plane view of another embodiment of the candle insert.

### DETAILED DESCRIPTION OF THE INVENTION

The present invention provides a candle insert appointed to be mounted within a candle holder to provide stability in order to mitigate the risk of the candle falling over while burning. The candle insert is constructed having a sleeve type construction wherein the sleeve/insert is simply slid over the base of the candle. The candle insert can come in a wide variety of shapes and sizes, corresponding to the wide array of candles in the marketplace. The candle types most suitable with the present invention include federal, pillar, and/or taper candles which are constructed as long, annular shapes appointed to be received in candle holders, chandeliers, and/candelabras. These types of long candles are extremely prone to falling over if not adequately stabilized in the respective holder.

In its preferred embodiment, the candle insert is constructed in a manner so that is it virtually invisible when in use, so it does not interfere with the ornamentality of the holder or candle. Therefore, preferably the candle insert is constructed of a transparent material, or of a material that correspondingly matches the candle holder. For example, the candle insert may be constructed of a transparent polymeric material; or have a brass show surface; or silver show surface. Most preferably however the candle insert is of such a narrow height so that it is flush with or shorter than the actual socket of the holder, and therefore cannot be seen protruding above the socket of the holder. The diameter of the candle insert is approximately ⅛ inch larger than the diameter of the given candle appointed to be used with the insert. The diameter therefore can be readily slid over the candle base, while at the same time sitting flush on the candle base. In this manner the grooves and ridges cooperate in concert to reduce the coefficient of sliding friction during mounting and removal of the candle insert within the candle holder, and to stabilize the candle during residence therein.

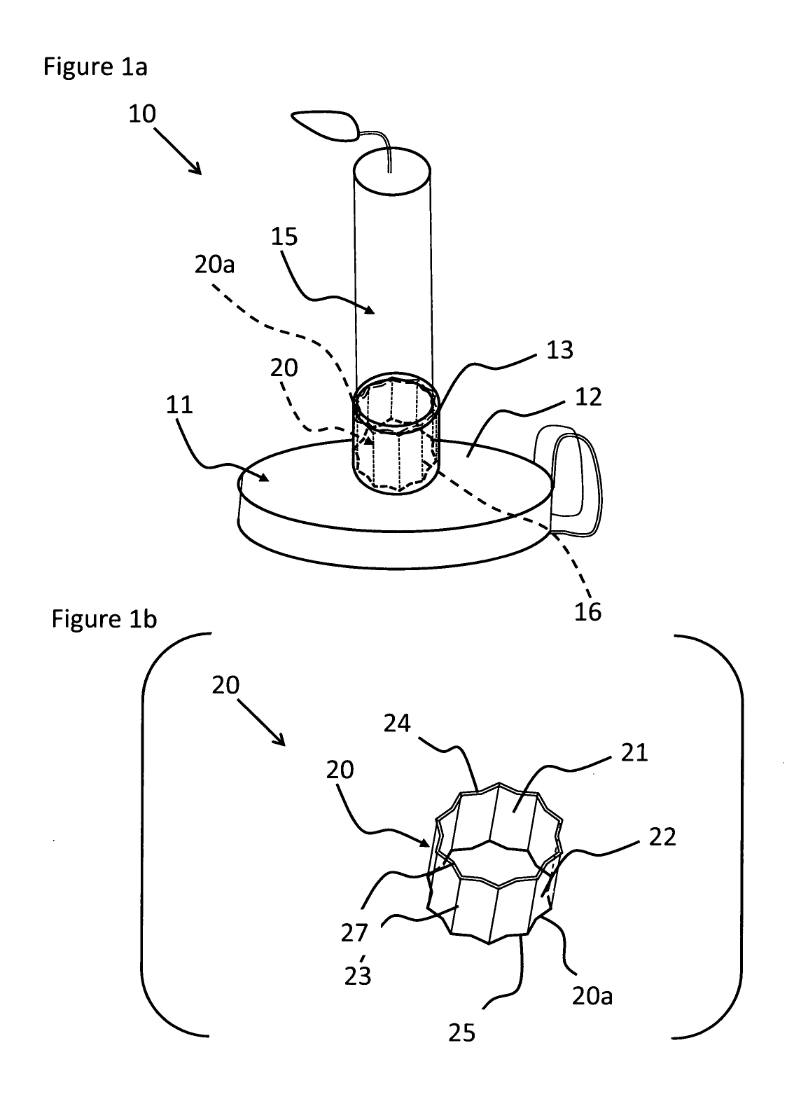

FIG. 1a illustrates a candle within an embodiment of the candle insert thereon mounted in a candlestick holder unit, shown generally at 10. FIG. 1b shows a top plane view of the candle insert embodiment of FIG. 1a, shown generally at 20. The candle insert 20 is shown placed within a candle holder 11 having a base 12 with a socket 13 appointed to receive the candle base 16. Although the candle holder 11 is constructed with a rather shallow socket 13, it is understood that the candle holder 11 may be constructed having a plethora of shapes and designs. For example, the candle holder can be a simple holder unit as shown, a tall holder, candelabra, or a chandelier. Candle insert 20 is placed within socket 13. A candle 15 having a candle base 16 is placed within candle insert 20 and consequently within socket 13 of base 12 of candle holder 11.

Candle insert 20 is constructed as a sleeve 20a having a top opening 24 and side walls 22 with an external surface appointed to engage with the socket 13 of a candle holder 11 and an internal cavity appointed to engage with a base of a candle. Preferably, insert 20 is constructed without a bottom wall, but with a bottom opening 25, although it should be understood that a bottom wall may be provided. Side walls 22 are appointed to embrace the candle base 16 of candle 13 in a substantially close-fitting manner. Insert 20 is adapted to be received within socket 13 of candle holder unit 11. Side walls 22 include a plurality of grooves 27 and peaks or ridges 23 forming a star shaped configuration integrated within the external surface. These grooves 27 cooperate with the peaks or ridges 23 to intimately engage with socket 13 of candle holder 11 to provide enhanced securement within base 12. The candle base 16 is inserted within the top opening 24 of the insert 20 so that the base insert's side walls 22 embrace the candle base 16. Insert 20 is in turn placed within the candle holder unit 11 with the grooves 27 as well as the peaks or ridges 23 integrated within the external surface of the side walls 22 of the insert 20 engaging with the candle holder unit 11 to securely mount and stabilize the candle 15 within the holder 11.

Preferably sleeve is tubular in shape and includes a bottom opening much like a ring to be inserted onto the candle base. In this manner the sleeve/insert can actually be slid upwardly or downwardly on the candle base to adjust its position on the candle and consequently within the socket of the candle holder. As shown in FIG. 1a and 1b, the candle insert is preferably shaped with a ten point star configuration forming the grooves 27 and ridges 23 (see FIGS. 3a-3d). Alternatively, the sleeve is constructed with an eight point star configuration forming the grooves and ridges. The star shaped configuration functions to provide the insert 20, to be applied to candles having a plurality of different base 16 constructs. That is to say, when the candle base 16 includes ridges and grooves, the grooves and ridges fit optimally in the grooves and ridges of the insert 20. Further, where the candle base 16 includes vertically parallel grooves, the star configuration of the insert 20 enables at least one parallel groove to be received in the ridges 23 of the insert 20. Where the candle base 16 is smooth, the grooves and ridges of the insert 20 slightly cut into the wax and act to further grip the candle. It has also been found that the star point configuration, preferably ranging from a six point configuration up to no greater than a ten point configuration (see FIGS. 3a-3d) provides the optimal configuration to ensure securement of the candle base 16 and securement within socket 13 of holder 11. A configuration having more than ten points tends to inhibit insertion onto the candle base 16, and occasionally requires the diameter of the candle base 16 to be trimmed, which can be a time consuming, cumbersome process.

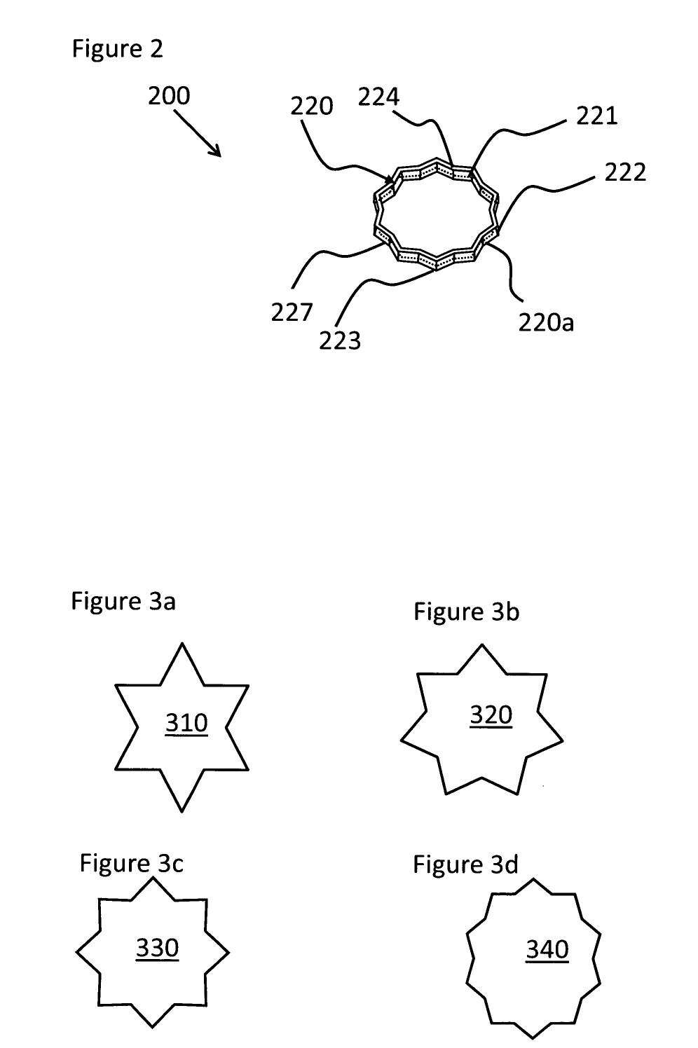

Preferably the insert 20 lies flush with socket 13. Most preferably insert 20 has a height less than that of socket 13. Side walls 22 of insert 20 are shorter in height than the socket 13 of the candle holder 11 so that the candle insert does not protrude over the socket 13. With this arrangement, insert 20 remains virtually invisible. The side walls 22 may indeed be so shallow in height that the insert 20 sleeve 20a appears more as a ring structure that sits low within socket 13 (see FIG. 2). Preferably the side walls 22 have a height ranging between 0.25 inches-3 inches, depending on the type of candle and candle holder being utilized. Wherein the candle is a conventional sized federal or tapered candle, the side walls 22 preferably have a height ranging between 0.25 inches-0.5 inches.

Insert 20 is typically constructed from a substantially rigid material, such as a rigid polymeric material or metal. Alternatively, the insert 20 is composed of a fibrous material, such as a cardboard material or cotton material. Insert 20 may be disposable. Alternatively, the insert 20 is composed of an elastic material so that is can be stretched over the candle base 16. Where the insert 20 is composed of elastic material, it is preferred that in sleeve 20a, the grooves 27 and ridges 23 have more rigidity. This is accomplished by applying a thin polymeric coating to grooves 27 and ridges 23.

FIG. 2 shows a top plane view of an embodiment of the candle insert wherein the insert is constructed with shallow side walls, shown generally at 200. The candle insert 220 is constructed as a sleeve 220a having a top opening 224 and shallow side walls 222 with an external surface appointed to engage with a socket of a candle holder and an internal cavity appointed to engage with a base of a candle. Side walls 222 are appointed to embrace a candle base in a substantially close-fitting manner. Side walls 222 include a plurality of grooves 227 and peaks or ridges 223 forming a star-shaped configuration integrated within the external surface. These grooves 227 cooperate with the peaks or ridges 223 to intimately engage with the socket of the candle holder and the candle base. In this embodiment, side walls 222 are shallow in height so that the sleeve 220a is formed similar to a ring-like structure that simply is slid onto the candle's base and adjusted so that is sits in the socket in a manner that makes the insert 220 virtually undetectable.

FIGS. 3a-3d show top plane views of embodiments of the candle insert, showing six point 310, seven point 320, eight point 330 and ten point 340 star configurations of the candle insert. The star-shaped configuration functions to provide an insert suitable for application to candles having a plurality of different base constructs, as discussed hereinabove.

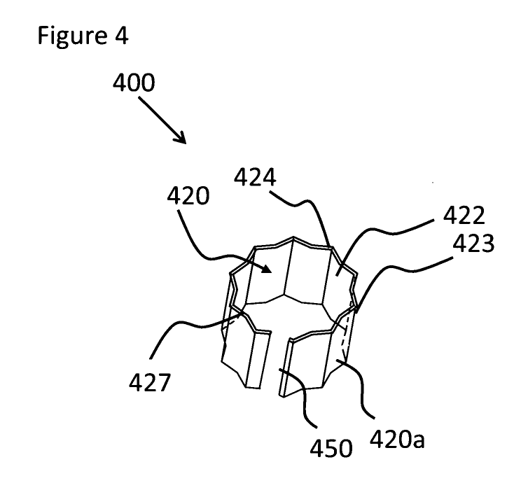

FIG. 4 shows a top plane view of another embodiment of the candle insert, shown generally at 400. The candle insert 420 is constructed as a sleeve 420a having a top opening 424 and shallow side walls 422 with an external surface appointed to engage with a socket of a candle holder and an internal cavity appointed to engage with a base of a candle. Side walls 422 are appointed to embrace a candle base in a substantially close-fitting manner. Side walls 422 include a plurality of grooves 427 and peaks or ridges 424 forming a star shaped configuration integrated within the external surface. These grooves 427 cooperate with the peaks or ridges 424 to intimately engage with the socket of the candle holder and the candle base. In this embodiment the side walls 422 include a vertical slot 450 so that the sleeve 420a has a substantially crescent-like shape. The slot 450 operates to expand the sleeve 420a during application thereof on the candle base, enabling insert 420 to tightly hug the candle base.

Having thus described the invention in rather full detail, it will be understood that such detail need not be strictly adhered to, but that additional changes and modifications may suggest themselves to one skilled in the art, all falling within the scope of the invention as defined by the subjoined claims.

What is claimed is:

1. A candle insert appointed to be mounted within a candle holder, comprising:
a. a sleeve having a top opening and side walls with an external surface appointed to engage with a socket of a candle holder and an internal cavity appointed to engage with a base of a candle;
b. said top opening having a substantially annular shape and being appointed to receive said base of said candle;
c. a plurality of grooves and ridges integrated within said external surface and said internal cavity of said side walls, and cooperating in concert to reduce sliding friction during mounting and removal of said candle insert within said candle holder and to stabilize said candle during residence therein.

2. A candle insert as recited by claim 1, wherein said sleeve is tubular.

3. A candle insert as recited by claim 1, wherein said side walls include a bottom opening.

4. A candle insert as recited by claim 1, wherein said side walls of said sleeve are shorter than said socket of said candle holder so that said candle insert does not protrude over said socket.

5. A candle insert as recited by claim 1, wherein said side walls are shallow in height.

6. A candle insert as recited by claim 5, wherein said sleeve comprises a shallow ring sleeve structure.

7. A candle insert as recited by claim 1, wherein said side walls have a height ranging between 0.25 inches-3 inches.

8. A candle insert as recited by claim 1, wherein said side walls have a height ranging between 0.25 inches-0.5 inches.

9. A candle insert as recited by claim 1, wherein said sleeve is constructed from a substantially rigid material.

10. A candle insert as recited by claim 1, wherein said sleeve is composed of a polymeric material.

11. A candle insert as recited by claim 1, wherein said sleeve is composed of a fibrous material.

12. A candle insert as recited by claim 11, wherein said sleeve is disposable.

13. A candle insert as recited by claim 1, wherein said sleeve is composed of an elastic material.

14. A candle insert as recited by claim 1, wherein said side walls of said sleeve include a vertical slot so that said sleeve has a substantially crescent-like shape.

15. A candle insert as recited by claim 1, wherein said sleeve is composed of a transparent material.

16. A candle insert as recited by claim 1, wherein said sleeve has a ten point star configuration forming said grooves and ridges.

17. A candle insert as recited by claim 1, wherein said sleeve has an eight point star configuration forming said grooves and ridges.
